(19) United States
(12) Patent Application Publication
(10) Pub. No.: US 2002/0068168 A1
(43) Pub. Date: Jun. 6, 2002

(54) Protection film for base sheet

(76) Inventor: Hisashi Kugimoto, Tokyo-to (JP)

Correspondence Address: LADAS & PARRY, 224 SOUTH MICHIGAN AVENUE, SUITE 1200, CHICAGO, IL, 60604, US

(21) Appl. No.: 10/003,362

(22) Filed: Nov. 15, 2001

(30) Foreign Application Priority Data
Dec. 4, 2000 (JP) 2000-368243

(51) Int. Cl. B32B 7/12

(52) U.S. Cl. 428/355 EN

(57) ABSTRACT

Provided is a protection film for a base sheet that excellently transmits ultraviolet rays through itself, that does not easily make any reactions with antistatic agent, and that has an appropriate level of adhesive strength. The protection film for a base sheet is the one that is used for the base sheet of a lens sheet. In this protection film, the lens sheet has its lens surface formed of a UV-curable resin layer; the protection film has provided on its one-surface side an adhesive agent layer; and the transmittance of ultraviolet rays of which wave length is 320 nm transmitting through the protection film is 82% or more.

### BACKGROUND OF THE INVENTION

1. Field of the Invention

The present invention relates to a protection film for a base sheet that is used for a lens sheet.

2. Description of the Related Art

A large-sized lens sheet that is used for a projection screen, etc. has the following construction. A liquid ultraviolet ray curable resin (that in the following description is referred to as “a UV-curable resin”), which has been dropped onto a molding die, is lidded with a base sheet made of, for example, an acrylic material. Then the base sheet is pressed from over its entire surface. Further, from above the base sheet, ultraviolet rays are radiated so as to transmit through the base sheet, to thereby cure the UV-curable resin. Thereby, the lens surface is formed.

The above-described base sheet is the one that is obtained by passing a molten acrylic material into between two pieces of rolls and thereby extrusion-molding into a sheet while the material is being cooled. There are cases where the base sheet that has been obtained by being molded in that way is kept stocked for a relatively long period of time until it is used in the process for forming the lens surface. During that moment, it is possible that the base sheet is contaminated or charged with electricity, with the result that dirt, dust, etc. attach onto the base sheet. Therefore, it is necessary to prevent that. For this reason, the base sheet has been coated on the surface thereof with an antistatic agent immediately after extrusion thereof, for the purpose of preventing dust, dirt, etc. from adhering to the base sheet.

Also, a method is adopted wherein a synthetic resin-made protection film having formed on its one-surface side an adhesive agent layer is pasted or adhered to both surfaces of the base sheet to thereby prevent the contamination or scratching of the surface of the base sheet.

However, in the above-described process of radiating ultraviolet rays, because the protection film is left on the one-surface side of the base sheet as it has adhered thereon, the ultraviolet rays need to transmit through the protection film and then reach the UV-curable resin. Accordingly, in order to cure the UV-curable resin sufficiently, it is wanted to use the protection film that has the nature of permitting easy transmission of the ultraviolet rays through it. In addition, since the surface of the base sheet has coated thereon an antistatic agent as stated previously, it is also necessary that the antistatic agent and the adhesive agent of the protection film make no chemical reactions with each other even over a long period of time during which the base sheet is in stock, and that one of the both agents be stable with respect to the other. Further, it is also necessary that the protection film be not easily exfoliated during the stock period of time whereas said both agents conversely have an adhesive strength that as the necessity arises permits them to be easily exfoliated from each other.

### SUMMARY OF THE INVENTION

Thereupon, the present invention has an object to provide a protection film for a base sheet that permits excellent transmission of ultraviolet rays through it, that does not easily make any chemical reactions with the antistatic agent, and that has an appropriate value of adhesive strength.

The present invention will hereafter be explained.

The present invention solves the above-described problems by providing a protection film for a base sheet of a lens sheet, wherein the lens sheet has its lens surface formed of a UV-curable resin layer; the protection film has provided on its one-surface side an adhesive agent layer; and the transmittance of ultraviolet rays of which wave length is 320 nm transmitting through the protection film is 82% or more. Here, the “ultraviolet-ray transmittance” means a transmittance value that has been obtained by reading three times the transmittance of ultraviolet rays, having a predetermined wavelength, passing through the sample in the wavelength range of 250 to 400 nm (nano-meters) by using a spectrophotometer for ultraviolet and visible region and calculating the arithmetical mean value of the thus-read transmittance values.

According to this mode of the invention, even if radiating ultraviolet rays with respect to the UV-curable resin layer so as to pass through the protection film, the most part of the ultraviolet rays can be transmitted through the protection film to reach the UV-curable resin layer. Therefore, it is possible to sufficiently cure the UV-curable resin.

In one aspect of the present invention, it maybe arranged that the adhesive strength of the protection film for the base sheet be set to be at a value of 0.4 to 2.3N/25 mm. Here, the “adhesive strength” means a value that is obtained through the performance of the testing method that is mentioned as follows. Namely, the adhesion surface of the protection film was pressure-bonded/adhered to a commercially available clean-surface acrylic plate that had been cut off to a size 25 mm wide and 125 mm long, with the use of a rubber roll device (the rubber hardness of which measured using a Shore rubber hardness tester is 80 degrees) which applied a weight of 6 kg per cm to an article to be rolled, and at a speed of 2 m min. The resulting acrylic plate was left to stand for 30 minutes as was. Thereafter, using a tensile tester, the both were peeled off (180-degree peel-off) from each other at a speed of 200 mm min. The peel-off force at this moment was measured. The resulting values were averaged to determine that adhesive strength.

If the adhesive strength is set like that, because the adhesive strength of the protection film falls within a predetermined range, there is no possibility that the protection film will unexpectedly be peeled off during its being stocked. Also, in case peeling off the protection film from the base sheet immediately before the resin molding process executed using a UV-curable resin, that film can be reasonably peeled off.

In another aspect of the present invention, in case the protection film for the base sheet has been pasted, from the side of the adhesive agent layer, onto the surface of the base sheet having coated thereon an antistatic agent containing a cationic surface active agent, it is possible to construct so that the surface resistivity after the lapse of one year of the base sheet may be maintained at a value of 10¹²Ω/□ or less. Here, the “surface resistivity” means the electrical resistance of the surface of an insulating material. This electrical resistance is measured between mutually opposite sides of a rectangle on the surface. The value that has been expressed in Ω (ohm) is assumed to have no dependency upon the dimensions of the rectangle and the thickness of the surface thin film.

If the invention has been constructed like that, the antistatic performance of the base sheet is maintained as is over a long period of time. Therefore, an accident wherein the base sheet adsorbs the dust in the air during its being stocked is prevented from occurring.

If the invention has been constructed like that, further, it maybe arranged that the adhesive agent be the one that contains a polyolefin-based resin component.

If such is so done, even in case the surface of the base sheet has been coated thereon with a cationic antistatic agent, the adhesive agent and the antistatic agent don't make any chemical reactions with each other. Therefore, it is possible to maintain the antistatic performance over a long period of time.

In each of the above-described modes of the present invention, it may be arranged that the material of the base sheet be an acrylic resin.

If such is so done, each of the above-described modes of the present invention can be applied with respect to the protection film for an acrylic-made base sheet.

The above-described functions and advantages of the present invention will become apparent from the embodiment that will be explained next.

### BRIEF DESCRIPTION OF THE DRAWINGS

FIG. 1 is a sectional view illustrating a protection film pasted on each of the surfaces of a base sheet;

FIG. 2 is a sectional view illustrating the relationship among the stamper, the UV-curable resin layer, the base sheet, and the protection film; and

FIG. 3 is a view illustrating the radiation of UV.

### DESCRIPTION OF THE PREFERRED EMBODIMENTS

The present invention will hereafter be explained on the basis of the embodiment illustrated in the appended drawings.

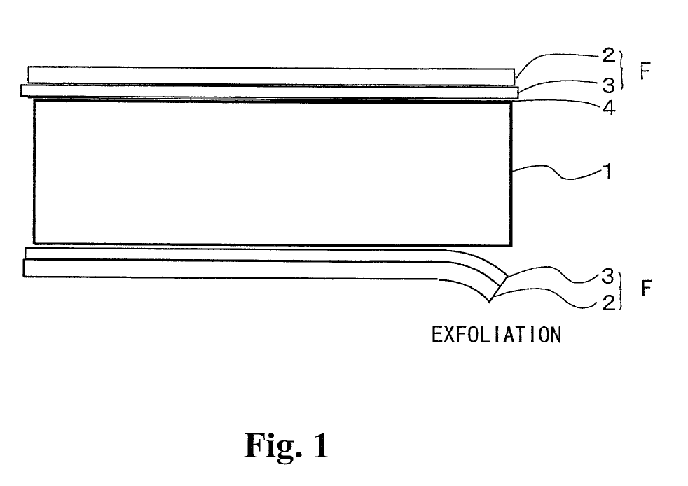

FIG. 1 is a sectional view illustrating a protection film F that has been adhered onto each of the surfaces of the base sheet 1. The protection film F comprises a synthetic resin film 2 and an adhesive agent layer 3 that has been formed on one surface side of the synthetic resin film 2. As the synthetic resin material, from the standpoint of its light transmission property being excellent, polyethylene, vinyl chloride copolymer, polypropylene, or a kneaded material of polyethylene and polypropylene is suitably used. As the adhesive agent constituting the adhesive agent layer 3 there is usually used by selection one of olefin-based, synthetic-rubber-based, and acrylic adhesive agents.

The base sheet 1 is the one that has been obtained by passing an acrylic resin, which has been heated at a high temperature to a molten state, through between two metal rolls so that it may be rolled while it is being cooled and by molding it into a plate-like acrylic plate. On the base sheet 1, after its being molded, on one surface thereof, an antistatic agent layer 4 is formed through the use of spray coating. As the antistatic agent forming the antistatic agent layer 4, for example, there is used a cationic surface active agent. The reason for coating the antistatic agent onto one surface of the base sheet 1 is for the purpose of, after the base sheet 1 is in stock or has become a product, preventing dirt, dust, etc. in the atmospheric air from adhereing to the surface of the base sheet 1 due to the static electricity.

There is a case where the base sheet 1 is stocked for a long period of time until it is used for molding the lens sheet. Accordingly, during that moment, the protection film F needs to hold an adhesive strength that is to such an extent as it cannot easily be exfoliated from the base sheet 1. From this point of view, the adhesive strength of the protection film F, preferably, is 0. 2N/25 mm or more, further preferably 0.4N/mm or more. Also, during that moment, the adhesive agent layer 3 of the protection film F and the antistatic agent layer 4 coated on the surface of the base sheet 1 are contacted with each other at all times in a planar state. Accordingly, it is necessary to examine a combination between the adhesive agent and the antistatic agent so that these two agents may not make a chemical reaction within a long period of time and so that the antistatic effect may persist. Here, as the antistatic agent for the base sheet 1, there is widely used a cationic surface active agent. Accordingly, it is necessary to select an adhesive agent that makes no chemical reaction with that cationic surface active agent. While, as stated previously, usually, the adhesive agent is used by being selected from among olefin-based, synthetic-rubber-based, or acrylic adhesive agents, here from the viewpoint of its chemical reactivity with the cationic antistatic agent being very low, synthetic-rubber-based adhesive agent, further preferably olefin-based adhesive agent is recommended for use.

The inventor of this patent application coated the cationic antistatic agent onto the base sheet 1 in an amount corresponding to 0.29 g/m². Thereafter, the protection film F equipped with the olefin-based adhesive agent layer was pasted onto the resulting base sheet 1. The resulting base sheet 1 was kept in custody for one year. Then the surface resistance value was measured using a surface ohmmeter (the model type: SM-8210 or SME-8310) that is made by Tokyo Denpa Co., Ltd. As a result, a value of 6.07×10¹⁰Ω was obtained. Usually, it is said that the surface resistance value that is the limit imposed upon the antistatic agent performance is 10¹²Ω. That obtained figure is the one that is sufficiently smaller than this value. Accordingly, the performance of the antistatic agent that is obtained from the above-described coating is judged as being at a fully satisfactory level.

In advance of the use for a UV curable resin molding process, one of the protection films F pasted on both surfaces of the base sheet 1 is exfoliated. At this time, it is preferable that the adhesive strength of the protection film F be set to be 3. 5N/25 mm or less, further preferably 2. 3N/25 mm or less so that that exfoliation operation may become easy to perform.

The base sheet 1 whose protection film F of the one-surface side having no antistatic agent coated thereon has been exfoliated is used in the UV-curable resin molding process.

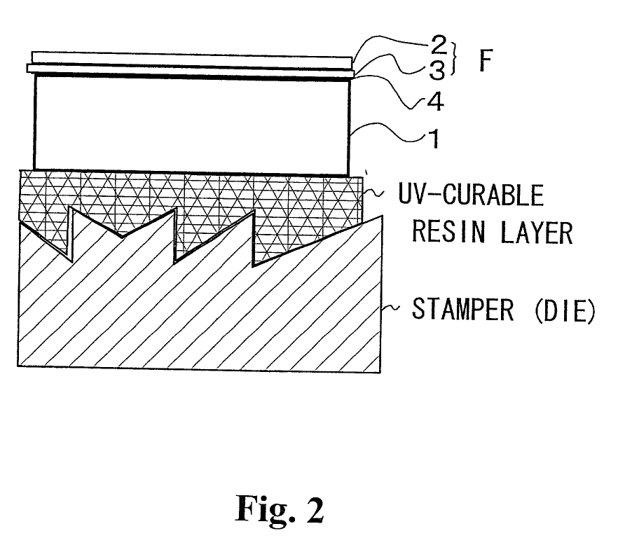

FIG. 2 is a sectional view illustrating the relationship that exists among a stamper (die), the UV-curable resin layer, the base sheet 1, and the protection film F in the UV-curable resin molding process. In the resin molding process, first, a liquid-state UV-curable resin is dropped onto the stamper that is a molding die. Next, the base sheet 1 is lidded over the upper surface of the UV-curable resin layer and is pressed against it over the entire surface of it. Through the execution of that process, the under side of the liquid-state UV-curable resin layer is cohered to the upper surface of the stamper that has formed thereon a reverse concavities/convexities configuration of the lens sheet. Resultantly, a normal concavities/convexities configuration of the lens sheet is transferred onto the underside of that resin layer. On the other hand, the upper surface of the liquid-state UV-curable resin layer coheres to the base sheet 1 of the surface side that the protection film F has been exfoliated. Thereby, the both elements are adhered to and integrated with each other.

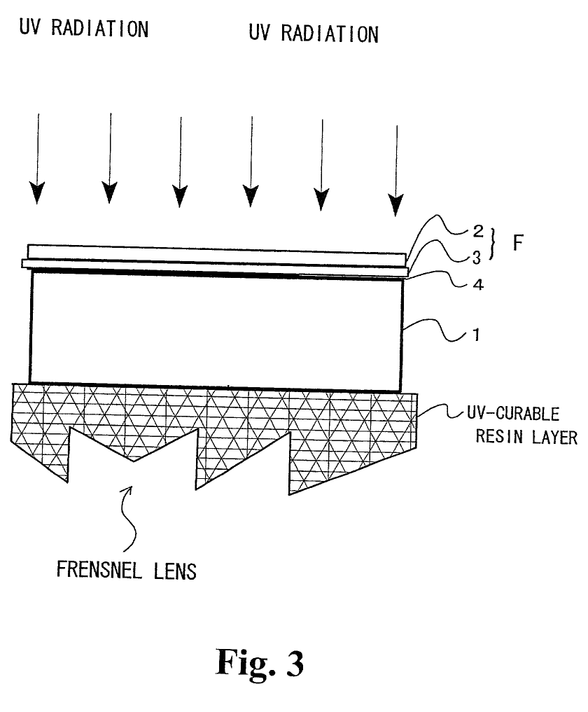

Further, as illustrated in FIG. 3, from above the protection film F and base sheet 1, ultraviolet rays are radiated so as to transmit through this film F and sheet 1 to thereby cure the UV-curable resin. With the use of that method, a sheet-like lens such as a Fresnel lens sheet is manufactured.

As will be apparent from FIG. 3 as well, in order that a sufficient amount of ultraviolet rays may arrive at the UV-curable resin layer, the protection film F needs to have the property of excellently transmitting ultraviolet rays. According to the present inventor's experiments, for example, a polyethylene film has more excellent transmission property of ultraviolet rays when compared with a polypropylene-based or vinyl-based film. Provided, however, that, for example, an ordinary polyethylene film that is used for agricultural use purposes, in many cases, has mixed therewith an ultraviolet ray absorption agent. Therefore, for the protection film F of the present invention, it is preferable to select and use a polyethylene film having no ultraviolet ray absorption agent mixed therewith. Concretely, a polyethylene film that has a figure of 75% or more, or further preferably 82% or more as the transmittance of ultraviolet rays the wavelength of that is for example 320 nm is recommended to be used.

Incidentally, in the above-described embodiment, as the lens sheet, there has been taken up an example regarding a Fresnel lens sheet. However, the present invention is not limited thereto. Namely, the present invention can of course be also applied to the protection film for the base sheet that is used for other lens sheets such as a lenticular lens sheet, a fly-eye lens sheet, or a linear Fresnel lens sheet, too.

The present invention is not limited to the above-described embodiments and permits changes or modifications to be suitably made without running counter to the subject matter or idea of the invention that is readable from the claims and the entire specification. The protection films for the base sheets that have been changed or modified as such are also included in the technical scope of the present invention.

According to the following protection film for the base sheet, the following advantages can be obtained. Namely, that protection film that as explained above is the one used for the base sheet for the lens sheet, the lens sheet having its lens surface formed of a UV-curable resin layer, the one-surface side of that protection film having provided thereon an adhesive agent layer, the transmittance of the ultraviolet rays of which wave length is 320 nm transmitting through the protection film is 82% or more. The advantages are that even when radiating ultraviolet rays onto the UV-curable resin layer so as to pass through the protection film, most part of the ultraviolet rays transmit through the protection film to reach the UV-curable resin layer, with the result that it is possible to sufficiently cure the UV-curable resin.

Also, if it is arranged that the adhesive strength of the protection film for the base sheet be 0. 4 to 2. 3N/25 mm, because the adhesive strength of the protection film falls within a predetermined range, there is no possibility that when the base sheet is being stocked the protection film will unexpectedly be exfoliated off. Also, in case peeling the film off the base sheet immediately before executing the resin-molding process, it is possible to perform reasonable peel-off of the film.

Also, if in case having pasted the protection film for the base sheet from the adhesive agent layer side onto the surface of the base sheet having coated thereon the antistatic agent including a cationic surface active agent it has been arranged that the surface resistivity after the lapse of one year of the base sheet be maintained at a value of 10¹²Ω/□ or less, the antistatic performance of the base sheet is maintained as is over a long period of time. This prevents the occurrence of an accident wherein the dust in the atmospheric air adheresa to the base sheet while the same is being stocked.

If in such a construction it is further arranged that the adhesive agent be the one that contains polyolefin-based resin components, even in case the surface of the base sheet has coated thereon a cationic antistatic agent, there is no possibility that the adhesive agent and the antistatic agent will make any chemical reactions with each other. Thereby, the antistatic performance can be maintained over a long period of time.

Further, if in the above-described modes of the present invention it is arranged that the material of the base sheet be acrylic compounds, each of the above-described modes of the present invention can be applied to the protection film of the acrylic-made base sheets.

What is claimed is

1. A protection film for a base sheet of a lens sheet, wherein
the lens sheet has its lens surface formed of a UV-curable resin layer;
the protection film has provided on its one-surface side an adhesive agent layer; and
a transmittance of ultraviolet rays of which wave length is 320 nm transmitting through the protection film is 82% or more.

2. A protection film for a base sheet according to claim 1, wherein an adhesive strength is from 0. 4 to 2. 3N/25 mm.

3.A protection film for a base sheet according to claim 1, wherein, in case the protection film for the base sheet has been pasted, from the side of the adhesive agent layer, onto a surface of the base sheet having coated thereon an antistatic agent containing a cationic surface active agent, a surface resistivity after a lapse of one year of the base sheet is maintained at a value of 10¹²Ω/□ or less.

4. A protection film for a base sheet according to claim 1 wherein
the adhesive agent is the one that contains a polyolefin-based resin component.

5. A protection film for a base sheet according to claim 1, wherein the material of the base sheet is an acrylic resin.
